(19) United States
(12) Patent Application Publication
(10) Pub. No.: US 2012/0167740 A1
(43) Pub. Date: Jul. 5, 2012

(54) Four-Edge Shear Baler Blade

(76) Inventors: Ryan Eldridge, Fishers, IN (US); Christopher Rasmussen, (US)

(21) Appl. No.: 13/276,914

(22) Filed: Oct. 19, 2011

Related U.S. Application Data
(60) Provisional application No. 61/429,544, filed on Jan. 4, 2011.

(51) Int. Cl. B23D 35/00

(52) U.S. Cl. 83/694

(57) ABSTRACT

An improved shear cutting blade comprising a plurality of opposing countersunk fastener holes and four cutting edges is disclosed. Four cutting edges and two mounting surfaces are provided, along with threaded, countersunk holes to allow fasteners to secure the blade in multiple orientations. The blade is ideally utilized in a compacting and baling process, wherein loose scrap metal and other material are pressed from a collection point and into a compaction chamber, wherein the blade is passed over the material as it is pressed into the chamber, shearing the debris into a compact, baled form. The blade can be rotated and secured against either mounting surface, and rotated to allow use of any of its four cutting edges, providing reusability and improved service life of a single blade during operation.

### CROSS REFERENCE TO RELATED APPLICATION

This application claims the benefit of U.S. Provisional Application No. 61/429,544 filed on Jan. 4, 2011, entitled “4 Edge Baler Shear Blade.”

### BACKGROUND OF THE INVENTION

1. Field of the Invention

The present invention relates to shear blades and baling devices. More specifically, the present invention relates to a modular shear baler blade that can be mounted in multiple configurations to allow use of different cutting edges, allowing improved service life of a single blade and reduced replacement and maintenance costs.

2. Description of the Prior Art

Shear balers are devices utilized to form compacted volumes of loose debris, utilizing a hydraulic press that forces the debris from a first container or hopper and into a smaller chamber that forms the baled shape. Shear blades are utilized to form the debris into the specific end-product shape, traditionally being a rectangular or cubic structure of compacted material. The blades contemplated in the present invention are utilized in a shearing operation, wherein material is pressed across a cutting edge and the blade remains in a static position, shaving or cutting material along a plane. These blades differ from other forms of cutters that utilize reciprocating motion or saw teeth to perform the cutting operation.

Traditional shear blades are elongated, rectangular structures that provide a plurality of fastener holes for mounting the blade to a larger assembly, and generally comprise one or two independent cutting edges. One of the cutting edges is used in the baling process until that blade has become sufficiently dulled to require its replacement. The blade is then removed and rotated to position a second cutting edge in a working position for application of the same blade but with a fresh cutting edge. Generally, the fastener holes are countersunk along a single surface of the blade, allowing the fastener heads to mount flushly with the outer surface of the blade once secured. However, this allows only a single orientation for the shear blade during operation, wherein one surface is allows flush with the baler assembly and another surface is always facing outward therefrom. Therefore, only two cutting edges are provided by a single blade for use in the baling operation.

The present invention provides a new shear cutting blade wherein all four edges of its rectangular cross section may be utilized as a cutting edge. Mounting holes are provided along its length, which are comprised of opposing countersinks wherein a fastener head may engage the blade from either side of the blade. In this way, the blade offers four separate edges for utilization during a baling process. The blade can be removed, rotated and reattached to position a new cutting edge in a working position in four distinct configurations, allowing improved operational life of a single blade. This also reduces replacement costs and maintenance of dulled blades.

Several devices have been disclosed in the prior art that relate to baling processes, and more specifically to baling processes utilizing a shear blade to shape and form loose debris into compacted bales. U.S. Pat. No. 2,145,405 to Schermerhorn is one such device that describes a shear blade intended for use in power shears employed in iron cutting, steel sheet or bar cutting. The blade comprises flat bottom surface with angular upper surfaces to provide a more satisfactory and cleaner cut with improved operational life than traditionally shaped blades used for the same purposes. While adapted for cutting iron for railroad applications, the Schermerhorn patent does not disclose a modular shear blade with four cutting edges that can be rotated and flipped to reuse the same blade for the given operation. Its structure teaches away from the present invention, which provides an improved operation life for a single blade by altering the cutting surface in the shearing apparatus.

U.S. Pat. No. 4,417,510 to Sharp is another device that describes a shear baler assembly designed to efficiently process large volumes of scrap metals into compact bundles, including a novel structure for mounting a shear blade. The shear blade used in the Sharp assembly includes an offset to allow different orientations of the blade, allowing slight angles to facilitate improved cutting of material as a ram forces material over its cutting edge and into a compacting chamber. The shear blade comprises opposing countersinks; however it is not adapted for use in multiple configurations. The present invention provides a blade that can be rotated lengthwise and about a vertical access to allow each edge of the cutting blade to be accessed and utilized in a shearing operation.

Both the Schermerhorn and Sharp patents disclose shear blades that can be utilized in a baling process; however they do not provide a 4-edged blade that is adapted for several reuses before replacement. The present invention increases the longevity and economy of a single blade, reducing spares and costs to the user. Its structure substantially diverges in design elements from the prior art and consequently it is clear that there is a need in the art for an improvement to existing shear baler blade devices. In this regard the instant invention substantially fulfills these needs.

### SUMMARY OF THE INVENTION

In view of the foregoing disadvantages inherent in the known types of shear baler blade devices now present in the prior art, the present invention provides a new shear blade wherein the same can be utilized for providing convenience for the user when utilizing the same blade in four distinct configurations and providing four cutting edges.

It is therefore an object of the present invention to provide a new and improved shear blade device that has all of the advantages of the prior art and none of the disadvantages.

Another object of the present invention to provide a shear baler blade that employs four cutting edges, improving the service life of a single blade and reducing spare parts, replacement costs and operational down time.

Another object of the present invention is to provide a shear baler blade with a plurality of opposing countersunk fastener holes that allow the blade to positioned in any direction or orientation with regard to a backing structure.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the present invention and a cross section location.

FIG. 2 shows a cross section view of the present invention along a countersunk fastener location.

FIG. 3 shows a front view of the present invention.

FIG. 4 shows a perspective view of the present invention in a working position and installed on a material compactor.

### DETAILED DESCRIPTION OF THE INVENTION

Reference is made herein to the attached drawings. Like reference numerals are used throughout the drawings to depict like or similar elements of the shear baler blade. For the purposes of presenting a brief and clear description of the present invention, the preferred embodiment will be discussed as used for providing a shear baler blade that has an extended service life and improved modularity. The figures are intended for representative purposes only and should not be considered to be limiting in any respect.

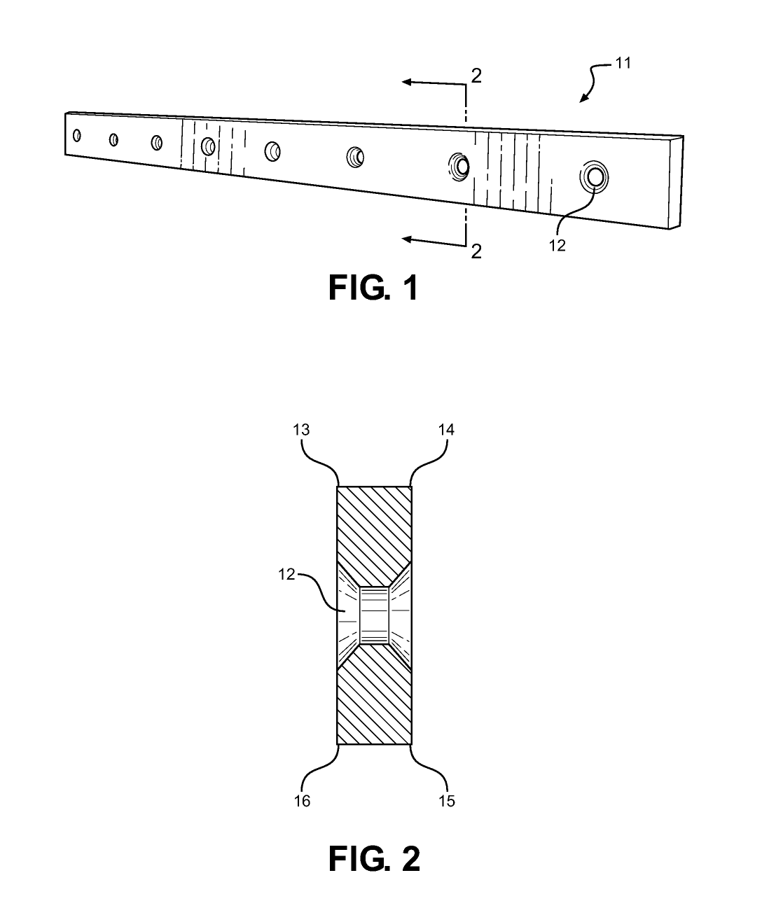

Referring now to FIG. 1, there is shown a frontal perspective view of a shear baler blade 11 as disclosed by the present invention. The shear blade 11 comprises a rectangular structure with four square edges defining its cross section and a plurality of through holes 12 protruding through its width. The holes 12 are countersunk on both the forward and rear surface of the blade 11, wherein they converge at the center of the blade width to form two opposing countersinks. The countersinks allow a countersunk fastener to be removably inserted therethrough, wherein the head of the fastener lies flush against the outer surface of the blade once installed. The four square edges of the blade cross section provide four independent cutting edges, which can each be oriented into a working position on a larger baling device and used for a given period of time. The opposing countersinks allow the blade to be placed in a first position, then flipped 180 degrees about a vertical, centroidal axis into a second position, flipped again 180 degrees about a horizontal, centroidal axis into a third position, and then flipped once again 180 degrees about the same vertical axis to position a fourth cutting edge into a working position. The order in which the rotations occur is not critical, but rather the ability to position any of the blade cutting edges into a working position is of particular novelty.

Referring now to FIG. 2, there is shown a cross section view of the cutting blade, wherein a section view is shown at a fastener location 12. Each fastener location 12 provides dual, opposing countersinks to accommodate a fastener from either side of the blade width. This design allows the blade to be mated against a larger device in any orientation, wherein either side of the blade may function as the backing surface that mounts flushly to the larger assembly. The four cutting edges 13,14,15,16 of the blade are independently positionable in a working position to cut or shave material that passes over the working edge, providing a device that may be used in a shearing operation.

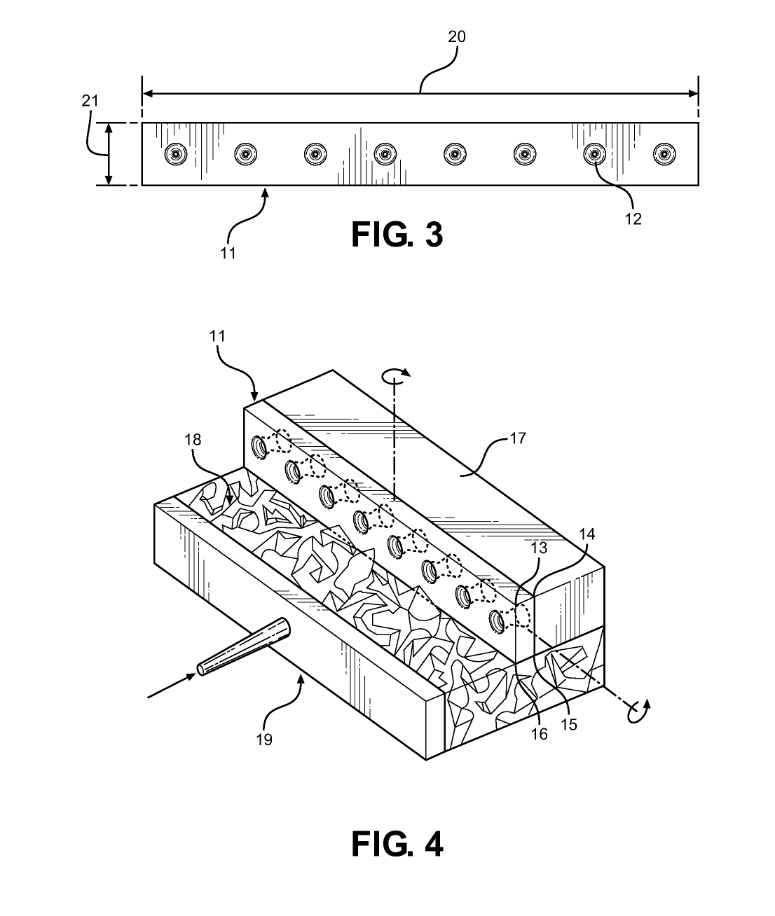

Referring now to FIG. 3, there is shown a front view of a shear baler blade 11 as disclosed by the present invention. The length 20 and height 21 of the blade are largely dependent upon the chosen application, and can be modified to fit a particular requirement. A plurality of fastener holes 12 are provided through the width of the blade 11, which allow the device to be mounted to a baling or compacting structure. Similar to dimensions, it is not desired to limit the chosen material for which the present invention is comprised; however, it has been shown that a blade comprising of 4340 annealed steel is particularly suited for scrap metal waste balers and compactors.

Referring now to FIG. 4, there is shown a perspective view of a shear baler blade 11 as disclosed by the present invention in a working position, secured to a baler device compacting loose, scrap material 18. A hydraulic press controls a ram 19 that forces scrap material 18 from a first location, generally a hopper or loading vessel, into a smaller chamber. As the material is forced therein, the material passes under the shear blade 11, wherein the cutting edge positioned in a working position 16 shears the material along a horizontal plane. The material is therefor compressed and shaped into the smaller volume, forming a compact, baled shape that can be further processed or shipped, as desired. As illustrated in FIG. 4, the blade 11 can be flipped and rotated about two centroidal axes, one in a vertical plane and the other in a horizontal plane. This allows the blade edges 13,14,15,16 to each be positioned in a working position if desired. FIG. 4 shows edge 16 in a working position, shearing material 18 as it is being compressed by the ram 19.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A shear baler cutting blade, comprising:
a rectangular section with a first, second, third and fourth square cutting edge, a section width and a first and second mounting surface;
said section having a plurality of fastener holes through said section width;
said fastener holes have opposing countersinks from said first and second mounting surface of said section;
said section mounting surfaces being adapted to mount against a flush surface to place either said first, second, third or fourth cutting edge into a working position.

2) A device as in claim 1, wherein said cutting blade comprises 4340 annealed steel material.
